(19) United States
(12) Patent Application Publication
(10) Pub. No.: US 2024/0202920 A1
(43) Pub. Date: Jun. 20, 2024

(54) SPATIAL ANALYSIS OF MITOTIC FIGURES IN HISTOPATHOLOGICAL IMAGES

(71) Applicants: Genentech, Inc., South San Francisco, CA (US); Ventana Medical Systems, Inc., Tucson, AZ (US); Hoffmann-La Roche Inc., Little Falls, NJ (US)

(72) Inventors: Xiao LI, Foster City, CA (US); Yao NIE, Tucson, AZ (US); Karol BADOWSKI, Warszawa (PL)

(21) Appl. No.: 18/542,088

(22) Filed: Dec. 15, 2023

Related U.S. Application Data
(60) Provisional application No. 63/387,934, filed on Dec. 16, 2022.

(51) Int. Cl. G06T 7/00; G06T 7/11; G06T 7/194; G06T 7/62; G06T 7/77

(52) U.S. Cl. CPC G06T 7/0012; G06T 7/11; G06T 7/194; G06T 7/62; G06T 7/77; G06T 2207/30096

(57) ABSTRACT

A method may include identifying, within an image of a biological sample, a plurality of mitotic figures associated with a tumor tissue present in the biological sample. Each mitotic figure of the plurality of mitotic figures may correspond to a tumor cell that is undergoing mitosis. A mitotic metric quantifying a spatial distribution of the plurality of mitotic figures within the biological sample may be determined based on the plurality of mitotic figures in the biological sample. A tumor grade for the tumor tissue present in the biological sample may be determined based on the mitotic metric. In some cases, at least one of a disease diagnosis, a disease progression, a disease burden, a treatment response, and a survival prognosis for a patient associated with the biological sample may be determined based on the tumor grade. Related systems and computer program products are also provided.

### CROSS-REFERENCE TO RELATED APPLICATIONS

This application claims priority to U.S. Provisional Application No. 63/387,934, filed Dec. 16, 2022, entitled “SPATIAL ANALYSIS OF MITOTIC FIGURES IN HISTOPATHOLOGICAL IMAGES,” the content of which is hereby incorporated by reference in its entirety.

### TECHNICAL FIELD

The subject matter described herein relates generally to digital image analysis and more specifically to the spatial analysis of mitotic figures in histopathological images.

### BACKGROUND

Digital pathology incorporates digital imaging into the practice of pathology in which diseases are investigated and diagnosed through the examination of biological samples such as tissue fragments, free cells, body fluids, and/or the like. Whereas a non-digital pathology workflow relies on glass specimen slides, a digital pathology workflow may include digitizing the glass specimen slides to generate digital pathology images for subsequent viewing and analysis. Biological samples of tissues, cells, and/or body fluids may provide an abundance of information on disease morphology, progression, and response at a cellular level. Digitizing the glass specimen slides may render this information more accessible for interpretation, management, integration, and sharing. Thus, in addition to optimizing diagnosis and clinical decisions, digital pathology may also improve patient monitoring, disease progression prediction, treatment response and prediction, personalized healthcare, dosing recommendations, and/or the like.

### SUMMARY

Systems, methods, and articles of manufacture, including computer program products, are provided for spatial analysis of mitotic figures in histopathological images. In some example embodiments, there is provided a system that includes at least one processor and at least one memory. The at least one memory may include program code that provides operations when executed by the at least one processor. The operations may include: identifying, within an image of a biological sample, a plurality of mitotic figures associated with a tumor tissue present in the biological sample, each mitotic figure of the plurality of mitotic figures corresponding to a tumor cell that is undergoing mitosis; determining, based at least on the plurality of mitotic figures in the biological sample, a mitotic metric quantifying a spatial distribution of the plurality of mitotic figures within the biological sample; and determining, based at least on the mitotic metric, a tumor grade for the tumor tissue present in the biological sample.

In another aspect, there is provided a method for spatial analysis of mitotic figures in histopathological images. The method may include: identifying, within an image of a biological sample, a plurality of mitotic figures associated with a tumor tissue present in the biological sample, each mitotic figure of the plurality of mitotic figures corresponding to a tumor cell that is undergoing mitosis; determining, based at least on the plurality of mitotic figures in the biological sample, a mitotic metric quantifying a spatial distribution of the plurality of mitotic figures within the biological sample; and determining, based at least on the mitotic metric, a tumor grade for the tumor tissue present in the biological sample.

In another aspect, there is provided a computer program product including a non-transitory computer readable medium storing instructions. The instructions may cause operations when executed by at least one data processor. The operations may include: identifying, within an image of a biological sample, a plurality of mitotic figures associated with a tumor tissue present in the biological sample, each mitotic figure of the plurality of mitotic figures corresponding to a tumor cell that is undergoing mitosis; determining, based at least on the plurality of mitotic figures in the biological sample, a mitotic metric quantifying a spatial distribution of the plurality of mitotic figures within the biological sample; and determining, based at least on the mitotic metric, a tumor grade for the tumor tissue present in the biological sample.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to spatial analysis of mitotic figures in histopathological images for tumor grading, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a system diagram illustrating an example of a digital pathology system, in accordance with some example embodiments;

FIG. 2 depicts a flowchart illustrating an example of a process for spatial analysis of mitotic figures in histopathological images, in accordance with some example embodiments;

FIG. 3A depicts a flowchart illustrating an example of a process for determining an average nearest neighbor distance, in accordance with some example embodiments;

FIG. 3B depicts a flowchart illustrating an example of a process for determining an average neighbor count within a radius, in accordance with some example embodiments;

FIG. 4A depicts graphs illustrating the distribution of one example of a mitotic metric observed in a whole tissue sample and tumor region sample across the spectrum of tumor grades, in accordance with some example embodiments;

FIG. 4B depicts graphs illustrating the distribution of another example of a mitotic metric observed in a whole tissue sample and tumor region sample across the spectrum of tumor grades, in accordance with some example embodiments;

FIG. 4C depicts graphs illustrating the distribution of another example of a mitotic metric observed in a whole tissue sample and tumor region sample across the spectrum of tumor grades, in accordance with some example embodiments;

FIG. 5 depicts an example of a histopathological image and visualizations of the mitotic figures present in the histopathological image, in accordance with some example embodiments; and

FIG. 6 depicts a block diagram illustrating an example of a computing system, in accordance with some example embodiments.

When practical, similar reference numbers denote similar structures, features, or elements.

### DETAILED DESCRIPTION

Digital pathology images of biological samples, such as whole slide microscopic images, may provide cellular and sub-cellular-level insights into disease morphology, progression, and response. The biological samples can include, but are not limited to, blood, plasma, tissue, saliva, any sample from an individual that contains cells, and subcellular components (e.g., nuclei and cell membranes). In some cases, the images of the biological samples may be treated with one or more stains, such as hematoxylin and eosin (H&E) stains, multiplex immunofluorescence (MxIF) stains, immunohistochemical (IHC) stains, and/or the like, in order to increase the visual differentiation between various biological tissues, cell populations, and/or cellular organelles present in the images of the biological samples. In one example application, digital pathology images may capture cellular biomarkers for use in biomarker discovery as well as biomarker-based diagnostics. In the field of oncology, for example, the grade of a tumor (e.g., well differentiated, moderately differentiated, poorly differentiated, or undifferentiated) and the patient's prognosis for surviving the disease may be determined based on the quantity of mitotic figures, or tumor cells that are in the process of dividing to form two separate tumor cells, identified in a sample of tumor tissue. However, conventional techniques for quantifying the mitotic figures present in a biological sample fail to capture the spatial distribution of the mitotic figures. As such, relying on conventional mitotic metrics when performing tumor grading and survival prognosis may lead to unreliable results.

In some example embodiments, a digital pathology platform may support a digital pathology workflow that includes a spatial analysis of the mitotic figures present in an image of a biological sample. For example, in some cases, the biological sample depicted in the image may include tumor tissue. Accordingly, the digital pathology platform may identify, in the image of the biological sample, a plurality of mitotic figures present in the tumor tissue. As used herein, the term “mitotic figure” may refer to a cell that is undergoing the process of mitosis, which is a part of the cell cycle in which the cell replicates its chromosomes before separating the replicated chromosomes into two new nuclei to form two new genetically identical cells. Upon identifying the plurality of mitotic figures, the digital pathology platform may determine a mitotic metric quantifying a spatial distribution of the mitotic figures in the biological sample. Examples of mitotic metrics quantifying the spatial distribution of mitotic figures in the biological sample may include an average mitotic density, an average nearest neighbor distance, an average neighbor count within a radius, a Clark-Evans (CE) index, a local Moran's I statistic, a local Geary's C statistic, and/or the like. In some cases, the digital pathology platform may determine, based at least on the mitotic metric, a tumor grade for the tumor tissue present in the biological sample. For instance, the digital pathology platform may determine, based at least on the mitotic metric, whether the tumor tissue in the biological sample is well differentiated, moderately differentiated, poorly differentiated, or undifferentiated. Alternatively and/or additionally, the digital pathology platform may determine, based at least on the mitotic metric or the tumor grade of the tumor tissue determined based on the mitotic metric, at least one of a disease diagnosis, a disease progression, a disease burden, a treatment response, and a survival prognosis for a patient associated with the biological sample.

In some example embodiments, the mitotic metric quantifying the spatial distribution of mitotic figures in the biological sample may include an average nearest neighbor distance. In some cases, the digital pathology platform may determine the average nearest neighbor distance of the mitotic figures in the biological sample by at least determining a distance between each pair of mitotic figures and identifying, based at least on the distance between each pair of mitotic figures, a shortest distance between each mitotic figure of the plurality of mitotic figures and another mitotic figure in the plurality of mitotic figures. The average nearest neighbor distance of the mitotic figures in the biological sample may be determined based at least on the shortest distance between each mitotic figure of the plurality of mitotic figures and the other mitotic figure in the plurality of mitotic figures. For example, in some cases, the average nearest neighbor distance of the mitotic figures in the biological sample may correspond to an average (or arithmetic mean) of the shortest distance between each mitotic figure of the plurality of mitotic figures and the other mitotic figure in the plurality of mitotic figures.

In some example embodiments, the mitotic figure quantifying the spatial distribution of mitotic figures in the biological sample may include an average neighbor count within a radius. In some cases, the digital pathology platform may determine the average neighbor count within the radius of the mitotic figures in the biological sample by at least determining a distance between each pair of mitotic figures included in the plurality of mitotic figures. Furthermore, the digital pathology platform may determine the average neighbor count within the radius of the mitotic figures in the biological sample by at least determining, based at least on the distance between each pair of mitotic figures included in the plurality of mitotic figures, a count of one or more other mitotic figures that are within the radius of each mitotic figure in the plurality of mitotic figures.

In some example embodiments, the mitotic figure quantifying the spatial distribution of mitotic figures in the biological sample may include a Clark-Evans (CE) index, which corresponds to a ratio between an average nearest neighbor distance and an expected nearest neighbor distance for the biological sample. In some cases, the digital pathology platform may determine the Clarks-Evans (CE) index of the biological sample by at least determining, for each mitotic figure of the plurality of mitotic figures, a distance to another mitotic figure of the plurality of mitotic figures that is a nearest neighbor. Moreover, to determine the Clarks-Evans (CE) index of the biological sample, the digital pathology platform may determine, for the plurality of mitotic figures, the average nearest neighbor distance for the biological sample as well as determine, based at least on a count of the plurality of mitotic figures and a size of the tumor in the biological sample, the expected average neighbor distance for the biological sample. In some cases, the size of the tumor in the biological sample may correspond to the area of the tumor region depicted in a two-dimensional image of the tumor or the volume of the tumor in a three-dimensional space. Furthermore, in some instances, the digital pathology platform may determine, based at least on whether the Clarks-Evans (CE) index of the biological sample is less than, equal to, or greater than a threshold value, that the plurality of mitotic figures in the biological sample exhibits an aggregated spatial distribution, a random spatial distribution, or an even spatial distribution.

In some example embodiments, the mitotic figure quantifying the spatial distribution of mitotic figures in the biological sample may include a measure of local spatial autocorrelation. One example measure of local spatial autocorrelation is a local Moran's I statistic for each region of a plurality of regions in the image of the biological sample. For example, in some cases, the digital pathology platform may determine a first local Moran's I statistic for a first region of the plurality of regions based on a first count of mitotic figures present in the first region and a weighted sum of mitotic figures present in each of a plurality of other regions. The weighted sum of mitotic figures present each of the plurality of other regions may include, for example, a second count of mitotic figures present in a second region where the second count is associated with a first weight if the second region is adjacent to the first region and a second weight if the second region is not adjacent to the first region. In some cases, the digital pathology platform may determine, based at least on the first local Moran's I statistic of the first region and a second local Moran's I statistic for a second region adjacent to the first region, that the first region and the second region exhibit a high-high spatial association, a low-low spatial association, a high-low spatial association, or a low-high spatial association.

In some example embodiments, another example measure of local spatial autocorrelation is a local Geary's C statistic for each region of a plurality of regions in the image of the biological sample. For example, in some cases, a first local Geary's C statistic of a first region of the plurality of regions in the image may correspond to a weighted sum of differences in a first count of mitotic figures present in the first region and a count of mitotic figures present in each of a plurality of other regions in the image. The aforementioned weighted sum may include, for example, a difference between the first count of mitotic figures present in the first region and a second count of mitotic figures present in a second region of the plurality of regions. In some cases, the difference may be associated with a first weight if the second region is adjacent to the first region and a second weight if the second region is not adjacent to the first region. The digital pathology platform may determine, based at least on the first local Geary's C statistic of the first region and a second local Geary's C statistic for a second region adjacent to the first region, that the first region and the second region exhibits a high-high spatial association or a low-low spatial association.

In some example embodiments, the digital pathology platform may exclude one or more mitotic figures identified within the image of the biological sample when determining the mitotic metric. For example, in order to exclude mitotic figures that are present in non-tumor tissue, the digital pathology platform may first segment the image of the biological sample into a first region corresponding to tumor tissue and a second region corresponding to non-tumor tissue. One or more mitotic figures identified within the second region of the image may be excluded from the plurality of mitotic figures such that the mitotic metric associated with the image may quantity the spatial distribution of mitotic figures present in the tumor tissue depicted in the image and not the spatial distribution of mitotic figures in the non-tumor tissue depicted in the image. Alternatively and/or additionally, the digital pathology platform may exclude one or more mitotic figures identified within a region of the image that is associated with a below-threshold intensity metric corresponding to an activity of the tumor within the region.

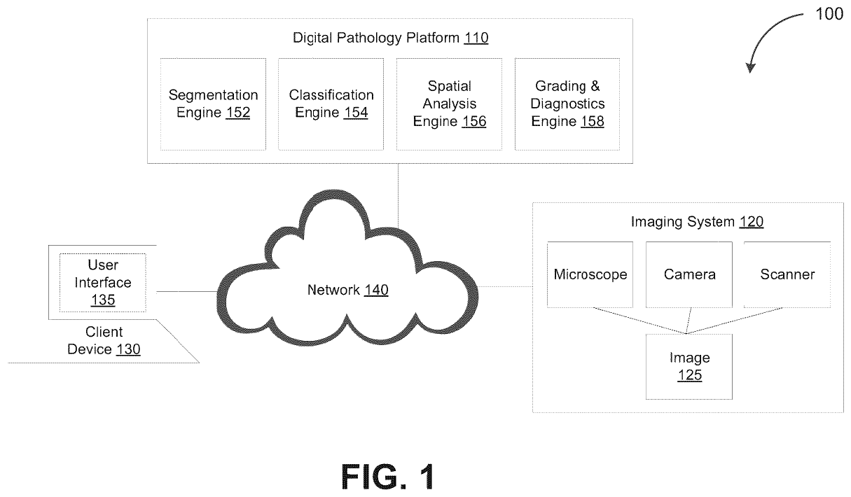

FIG. 1 depicts a system diagram illustrating an example of a digital pathology system 100, in accordance with some example embodiments. Referring to FIG. 1, the digital pathology system 100 may include a digital pathology platform 110, an imaging system 120, and a client device 130. As shown in FIG. 1, the digital pathology platform 110, the imaging system 120, and the client device 130 may be communicatively coupled via a network 140. The network 140 may be a wired network and/or a wireless network including, for example, a local area network (LAN), a virtual local area network (VLAN), a wide area network (WAN), a public land mobile network (PLMN), the Internet, and/or the like. The imaging system 120 may include one or more imaging devices including, for example, a microscope, a digital camera, a whole slide scanner, a robotic microscope, and/or the like. The client device 130 may be a processor-based device including, for example, a workstation, a desktop computer, a laptop computer, a smartphone, a tablet computer, a wearable apparatus, and/or the like.

Referring again to FIG. 1, the digital pathology platform 110 may include a segmentation engine 152, a classification engine 154, a spatial analysis engine 156, and a grading and diagnostics engine 158. In some example embodiments, the digital pathology platform 110 may support a digital pathology workflow that includes a spatial analysis of mitotic figures present in an image 125 generated by the imaging system 120. For example, the image 125 may depict a biological sample (or a derivation of a biological sample) that includes one or more of a tissue fragment, a free cell, or a bodily fluid. In some cases, the image 125 may be a whole slide image (WSI) that has been treated with one or more stains such as a hematoxylin and eosin (H&E) stain, a multiplex immunofluorescence (MxIF) stain, an immunohistochemical (IHC) stain, and/or the like. Moreover, the biological sample depicted in the image 125 may include tumor tissue and, in some cases, non-tumor tissue (e.g., connective tissue, epithelial tissue, muscle tissue, nervous tissue, and/or the like). Accordingly, in some cases, the digital pathology platform 110, for example, the segmentation engine 152, may segment the image 125 of the biological sample into a first region corresponding to the tumor tissue and a second region corresponding to the non-tumor tissue such that the mitotic figures present in the second region of the image 125 may be excluded from downstream spatial analysis.

In some example embodiments, the digital pathology platform 110 may identify a plurality of mitotic figures present in the biological sample such as, in some cases, the mitotic figures that are present in the tumor tissue but not the non-tumor tissue included in the biological sample. Furthermore, the digital pathology platform 110 may determine a mitotic metric quantifying a spatial distribution of the plurality of mitotic figures in the biological sample. Examples of the mitotic metric may include an average mitotic density, an average nearest neighbor distance, an average neighbor count within a radius, a Clark-Evans (CE) index, a local Moran's I statistic, a local Geary's C statistic, and/or the like. In some cases, the digital pathology platform 110 may determine, based at least on the mitotic metric, a tumor grade for the tumor tissue present in the biological sample. Moreover, in some cases, the digital pathology platform 110 may determine, based at least on the mitotic metric or the tumor grade determined based on the mitotic metric, at least one of a disease diagnosis, a disease progression, a disease burden, a treatment response, and a survival prognosis for a patient associated with the biological sample.

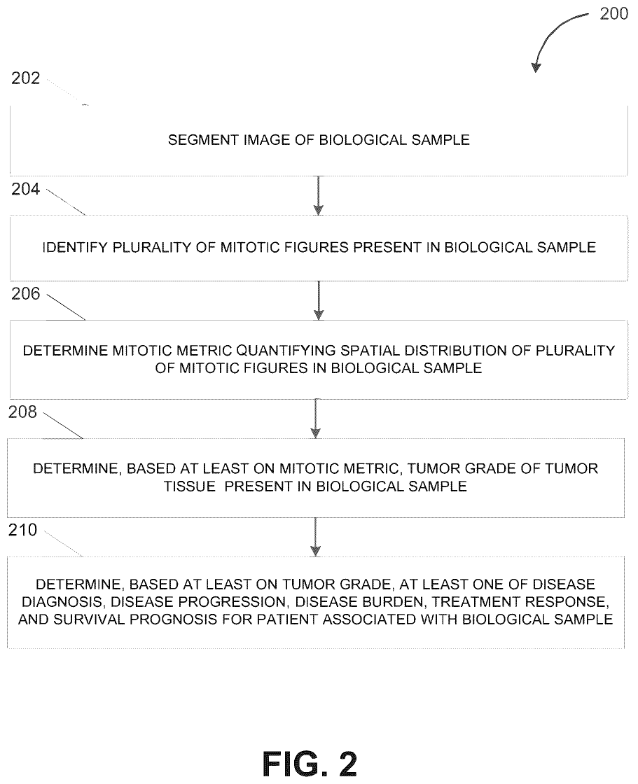

FIG. 2 depicts a flowchart illustrating an example of a process 200 for spatial analysis of mitotic figures in histopathological images, in accordance with some example embodiments. In some example embodiments, the process 200 may be performed by the digital pathology platform 110 to determine a spatial distribution of mitotic figures in the biological sample depicted, for example, in the image 125 generated by the imaging system 120. In some cases, the digital pathology platform 110 may perform the process 200 to at least generate a mitotic metric quantifying the spatial distribution of mitotic figures in the biological sample depicted in the image 125. Moreover, in some cases, the digital pathology platform 110 may perform the process 200 to at least determine a tumor grade for a tumor tissue included in the biological sample depicted in the image 125 and at least one of a corresponding disease diagnosis, disease progression, disease burden, treatment response, and survival prognosis for a patient associated with the biological sample.

At 202, the digital pathology platform 110 may segment an image of a biological sample. In some example embodiments, the digital pathology platform 110, for example, the segmentation engine 152, may segment the image 125 of the biological sample into a first region corresponding to the tumor tissue and a second region corresponding to the non-tumor tissue such as connective tissue, epithelial tissue, muscle tissue, nervous tissue, and/or the like. In some cases, the segmentation engine 152 may also identify a third region of the image 125 that is associated with a below-threshold intensity metric indicative of a below-threshold tumor activity. As will be explained in more detail below, the mitotic figures that are identified within the second region corresponding to the non-tumor tissue and/or the third region exhibiting a below-threshold tumor activity may be excluded from downstream spatial analysis. In some cases, the segmentation engine 152 may further identify a fourth region of the image 125 corresponding to a background of the image 125. It should be appreciated that the identification of mitotic figures may, in some cases, exclude the fourth region corresponding to the background of the image 125.

At 204, the digital pathology platform 110 may identify a plurality of mitotic figures present in the biological sample. In some example embodiments, the digital pathology platform 110, for example, the classification engine 154, may identify one or more mitotic figures present in the image 125. For example, in some cases, the classification engine 154 may apply a first machine learning model (e.g., a neural network and/or the like) trained to identify, within the image 125, one or more candidate mitotic figures before applying a second machine learning model (e.g., another neural network and/or the like) to eliminate one or more false positive candidate mitotic figures. Moreover, in some cases, when identifying the one or more mitotic figures present in the image 125, the classification engine 154 may avoid the second region of the image 125 corresponding to the non-tumor tissue, the third region of the image 125 exhibiting a below-threshold tumor activity, and/or the fourth region of the image 125 corresponding to the background of the image 125.

At 206, the digital pathology platform 110 may determine a mitotic metric quantifying a spatial distribution of the plurality of mitotic figures in the biological sample. In some example embodiments, the digital pathology platform 110, for example, the spatial analysis engine 156, may determine a first count of mitotic figures present in the image 125. In some cases, the first count of mitotic figures present in the image 125 may corresponding to a quantity of mitotic figures present in the entirety of the image 125 or a quantity of mitotic figures present in one or more portions of the image 125. For example, in some cases, the spatial analysis engine 156 may partition the image 125 into one or more regions (e.g., equal sized regions) before determining, for each region, a corresponding count of mitotic figures present therein. Doing so may enable the spatial analysis engine 156 to quantify, based at least on the count of mitotic figures present in each region of the image 125, a corresponding level of mitotic activities associated with each region of the image 125. Moreover, in some cases, the spatial analysis engine 156 may identify one or more regions of the image 125 exhibiting a highest level of mitotic activity or exhibiting a level of mitotic activity that satisfies one or more thresholds.

In some example embodiments, the spatial analysis engine 156 may determine, based at least on the first count of mitotic figures present in the image 125, a mitotic metric quantifying a spatial distribution of mitotic figures in the biological sample depicted in the image 125. As will be described in more details below, examples of mitotic metrics quantifying the spatial distribution of mitotic figures may include an average mitotic density, an average nearest neighbor distance, an average neighbor count within a radius, a Clark-Evans (CE) index, a local Moran's I statistic, a local Geary's C statistic, and/or the like. In some cases, the first count of mitotic figures used to determine the mitotic metric may be limited to mitotic figures identified within the first region of the image 125 corresponding to tumor tissue. Moreover, in some cases, the first count of mitotic figures used to determine to mitotic metric may be further limited to mitotic figures identified within one or more portions of the first region of the image 125 in which the activity level of the tumor satisfy one or more thresholds (e.g., above-threshold intensity metric indicative of an above-threshold level of tumor activity). Accordingly, in some cases, the first count of mitotic figures used to determine the mitotic metric may exclude a second count of mitotic figures present in the second region of the image 125 corresponding to a non-tumor tissue (e.g., connective tissue, epithelial tissue, muscle tissue, nervous tissue, and/or the like). Alternatively and/or additionally, the first count of mitotic figures used to determine the mitotic metric may exclude a third count of mitotic figures present in the third region of image 125 in which the activity level of the tumor fails to satisfy one or more thresholds.

At 208, the digital pathology platform 110 may determine, based at least on the mitotic metric, a tumor grade for the tumor tissue present in the biological sample. In some example embodiments, the digital pathology platform 110, for example, the grading and diagnostics engine 158, may determine, based at least on the mitotic metric associated with the image 125, a tumor grade for the tumor tissue present in the biological sample depicted in the image 125. In some cases, the tumor grade for the tumor tissue may include one or more of Grade I or low grade, Grade II or intermediate grade, Grade III or high grade, and Grade IV or high grade. Alternatively and/or additionally, in some cases, the tumor grade for the tumor tissue may include one or more of well differentiated, moderately differentiated, poorly differentiated, and undifferentiated. In some cases, in addition to the mitotic metric quantifying the spatial distribution of mitotic figures in the biological sample, the tumor grade for the tumor tissue may be further determined based on other mitotic metrics, such as a count of mitotic figures. For example, in some cases, the count of mitotic figures may correspond to a quantity of mitotic figures identified in one or more fields of view of the image 125. In some cases, these one or more fields may be associated with a magnification level satisfying one or more thresholds (e.g., high-power (high magnification) field-of-view). Furthermore, in some cases, the count of mitotic figures may be a part of one or more user inputs received from the client device 130.

At 210, the digital pathology platform 110 may determine, based at least on the tumor grade, at least one of a disease diagnosis, a disease progression, a disease burden, a treatment response, and a survival prognosis for a patient associated with the biological sample. In some example embodiments, the digital pathology platform 110, for example, the grading and diagnostics engine 158, may determine, based at least on the tumor grade associated with the tumor tissue included in the biological sample depicted in the image 125, one or more of a disease diagnosis, a disease progression, a disease burden, a treatment response, and a survival prognosis for a patient associated with the biological sample.

As noted, in some example embodiments, the digital pathology platform 110, for example, the spatial analysis engine 156, may determine a mitotic metric quantifying a spatial distribution of mitotic figures in the biological sample depicted in the image 125. One example of the mitotic metric quantifying the spatial distribution of mitotic figures in the biological sample is an average nearest neighbor distance, which may correspond to an average (or arithmetic mean) of the shortest distance between each mitotic figure of the plurality of mitotic figures and another mitotic figure in the plurality of mitotic figures. In some cases, the spatial analysis engine 156 may determine the average nearest neighbor distance of the mitotic figures in the biological sample by at least determining a distance between each pair of mitotic figures and identifying, based at least on the distance between each pair of mitotic figures, a shortest distance between each mitotic figure of the plurality of mitotic figures and another mitotic figure in the plurality of mitotic figures. The average nearest neighbor distance of the mitotic figures in the biological sample may be determined based at least on the shortest distance between each mitotic figure of the plurality of mitotic figures and another mitotic figure in the plurality of mitotic figures.

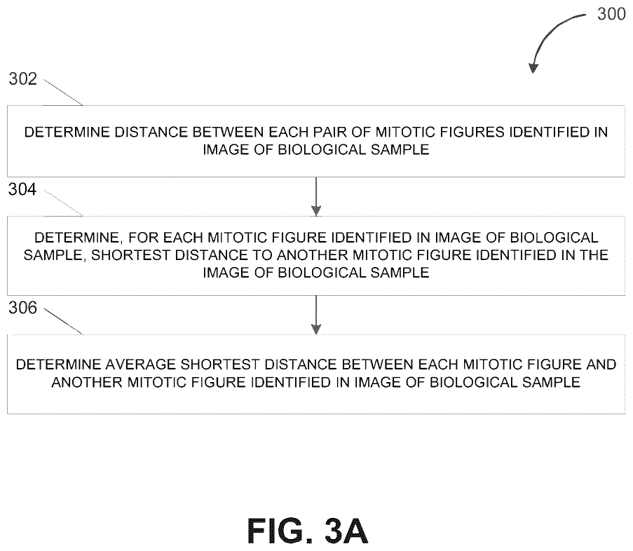

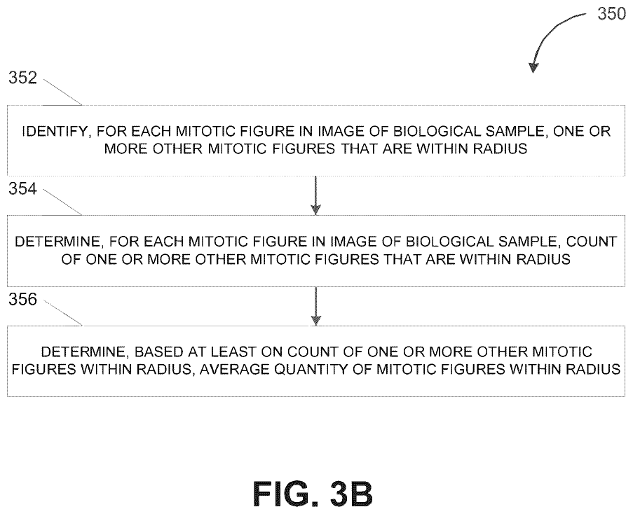

To further illustrate, FIG. 3A depicts a flowchart illustrating an example of a process 300 for determining an average nearest neighbor distance, in accordance with some example embodiments. Referring to FIGS. 1-2 and 3A, the process 300 may be performed by the digital pathology platform 110, for example, the spatial analysis engine 156. Moreover, in some cases, the process 300 may implement, at least partially, operation 206 of the process 200 described with respect to FIG. 2.

At 302, the digital pathology platform 110 may determine a distance between each pair of mitotic figures identified in an image of a biological sample. In some example embodiments, the digital pathology platform 110, for example, the spatial analysis engine 156, may determine the distance between each pair of mitotic figures identified within the image 125 of the biological sample. In some cases, the spatial analysis engine 156 may determine the distance between each pair of mitotic figures that are identified within a first region of the image 125 corresponding to the tumor tissue. Alternatively and/or additionally, the spatial analysis engine 156 may determine the distance between each pair of mitotic figures that are identified within one or more portions of the first region of the image 125 in which the activity level of the tumor satisfy one or more thresholds (e.g., above-threshold intensity metric indicative of an above-threshold level of tumor activity). In some cases, where an N-quantity of mitotic figures are identified in the image 125, the spatial analysis engine 156 may save, in an N×N matrix, the distance between each pair of mitotic figures identified in the image 125. Moreover, in some cases, the distance between a pair of mitotic figures may correspond to a quantity of pixels between the two mitotic figures and/or a unit of length (e.g., micrometer and/or the like) determined based on the quantity of pixels between the two mitotic figures and the length of the individual pixels.

At 304, the digital pathology platform 110 may determine, for each individual mitotic figure identified in the image of the biological sample, a shortest distance to another mitotic figure identified in the image of the biological sample. In instances where the distance between each pair of mitotic figures identified in the image 125 of the biological sample is saved to the N×N matrix, each mitotic figure of the N quantity of mitotic figures may correspond to a row in the N×N matrix while the distance to the other mitotic figures may occupy the corresponding columns. That is, each value d_{i,j} occupying the i-th row and j-th column of the N×N matrix may correspond to a distance between an i-th mitotic figure and a j-th mitotic figure in the image 125 of the biological sample. Accordingly, the shortest distance between a mitotic figure to another mitotic figure in the image 125 may be determined by identifying the smallest value in a corresponding row of the N×N matrix while excluding the distance between the mitotic figure to itself (e.g., where i=j). In some cases, the spatial analysis engine 156 may save, for example, in a table containing an N quantity of elements, the smallest distance between each mitotic figure and another mitotic figure in the image 125 of the biological sample as the nearest neighbor distances.

At 306, the digital pathology platform 110 may determine an average of the shortest distance between each mitotic figure and another mitotic figure identified in the image of the biological sample. In some example embodiments, the spatial analysis engine 156 may determine the average nearest neighbor distance by at least determining an average of shortest distances between each mitotic figure and another mitotic figure in the image 125 of the biological sample. For example, in some cases, the spatial analysis engine 156 may determine a sum of the values included in the N-element table before dividing the sum by N to determine the average nearest neighbor distance of the mitotic figures in the biological sample depicted in the image 125.

In some example embodiments, an average neighbor count within a radius is another example of the mitotic metric quantifying a spatial distribution of mitotic figures in the image 125 of the biological sample. In some cases, the radius within which to determine the average neighbor count may be specified by one or more user inputs received from the client device 130. Moreover, in some cases, the digital pathology platform 110, for example, the spatial analysis engine 156, may determine the average neighbor count within a radius of the mitotic figures in the biological sample by at least determining a distance between each pair of mitotic figures identified in the image 125 of the biological sample before determining, based at least on the distance between each pair of mitotic figures, a count of one or more other mitotic figures that are within the radius.

To further illustrate, FIG. 3B depicts a flowchart illustrating an example of a process 350 for determining an average neighbor count within a radius, in accordance with some example embodiments. Referring to FIGS. 1-2 and 3B, the process 350 may be performed by the digital pathology platform 110, for example, the spatial analysis engine 156. Moreover, in some cases, the process 350 may implement, at least partially, operation 206 of the process 200 described with respect to FIG. 2.

At 352, the digital pathology platform 110 may identify, for each mitotic figure identified in an image of a biological sample, one or more other mitotic figures that are within a radius. In some example embodiments, the digital pathology platform 110, for example, the spatial analysis engine 156, may identify, for each mitotic figure identified in the image 125 of the biological sample, one or more other mitotic figures that are within a radius. In some cases, the spatial analysis engine 156 may generate an N×N matrix in which each value d_{i,j} occupying the i-th row and j-th column of the N×N matrix may correspond to a distance between an i-th mitotic figure and a j-th mitotic figure in the image 125 of the biological sample. The spatial analysis engine 156 may update the N×N matrix by at least replacing each value d_{i,j} with a first value (e.g., “1”) if the value d_{i,j} is within the radius and a second value (e.g., “0”) if the value d_{i,j} is not within the radius. For those entries in the N×N corresponding to the distance between a mitotic figure and itself (e.g., where i=j), the spatial analysis engine 156 may replace the value of d_{i,j} with the second value (e.g., “0”) in order to exclude the mitotic figure as its own neighbor.

At 354, the digital pathology platform 110 may determine, for each mitotic figure identified in the image of the biological sample, a count of the one or more other mitotic figures that are within the radius. In some example embodiments, the spatial analysis engine 156 may determine, for each mitotic figure in the image 125 of the biological sample, a count of other mitotic figures that within the radius. For example, in some cases, the spatial analysis engine 156 may determine, for each mitotic figure identified in the image 125, the quantity of occurrences of the first value (e.g., “1”) in the corresponding row of the N×N matrix. In some cases, the count of neighbors within the radius of each mitotic figure identified in the image 125 may be determined by determining a sum of the first value (e.g., “1”) in the corresponding row of the N×N matrix. Moreover, in some cases, the spatial analysis engine 156 may save, for example, in a table containing an N quantity of elements, the quantity of mitotic figures that are within the radius of every N quantity of mitotic figures identified in the image 125 of the biological sample.

At 356, the digital pathology platform 110 may determine, based at least on the count of the one or more other mitotic figures within the radius, an average quantity of mitotic figures within the radius. In some example embodiments, the spatial analysis engine 156 may determine the average neighbor count within a radius of the mitotic figures in the image 125 of the biological sample by at least determining a sum of the values occupying the N-element table before dividing the sum by N.

In some example embodiments, a Clark-Evans (CE) index is another example of the mitotic metric quantifying the spatial distribution of mitotic figures identified in the image 125 of the biological sample. In some cases, the Clark-Evans (CE) index may correspond to a ratio between an average nearest neighbor distance and an expected nearest neighbor distance for the biological sample depicted in the image 125. Equation (1) below expresses the mean distance r̅_̅{̅A̅}̅ to a nearest neighbor in the biological sample depicted in the image 125.

$$\overline{{r}_{A}} = \frac{Σ {r}_{i}}{n} \qquad ( 1 )$$

wherein rᵢ denotes the distance to a nearest neighbor for the individual mitotic figure i and n denotes the quantity of mitotic figures in a particular area (e.g., one or more regions of the image 125 corresponding to the tumor tissue, exhibiting a level of tumor activity that satisfies one or more thresholds, and/or the like).

Given that the density p of mitotic figures in the biological sample corresponds to a ratio of the quantity of mitotic figures in a particular area and the size of the area (e.g., ρ=

$$\frac{quantity of mitotic figures in area}{size of area} ) ,$$

the expected distance _̅{̅E̅}̅ to a nearest neighbor may be defined by Equation (2) below.

$$\overline{{r}_{E}} = \frac{1}{2 \sqrt{ρ}} \qquad ( 2 )$$

The deviation from the observed pattern from the expected random pattern may be measured by the index of aggregation R defined by Equation (3) below. In some cases, where the spatial distribution of mitotic figures in the biological sample is random, the value of the index of aggregation R may equal 1. Where clumping is present in the spatial distribution of mitotic figures in the biological sample, the value of the index of aggregation R may approach zero. Meanwhile, where the spatial distribution of mitotic figures in the biological sample exhibits a regular pattern, the value of the index of aggregation R may approach an upper limit of, for example, 2.15.

$$R = \frac{\overline{{r}_{A}}}{\overline{{r}_{E}}} \qquad ( 3 )$$

In some example embodiments, local Moran's I statistic is another example of the mitotic metric quantifying the spatial distribution of mitotic figures in the biological sample depicted in the image 125. In some cases, the local Moran's I statistic of the mitotic figures may quantify a global spatial autocorrelation of the mitotic figures present different regions in the biological sample depicted in the image 125. Moreover, in some cases, the spatial analysis engine 156 may determine the local Moran's I statistic of the mitotic figures in the biological sample by applying Equation (4) below.

$${I}_{i} = {z}_{i} {Σ}_{j}^{n} {w}_{i j} {z}_{j} \qquad ( 4 )$$

wherein zᵢ and zⱼ denote the standardized prevalence of mitotic figures at areal units i and j while wᵢⱼ denotes the binary weight for the areal unit i and j. In this case, the binary weight wᵢⱼ may have a first value (e.g., 1) if two areal units are neighbors and a second value (e.g., 0) if two areal units are not neighbors.

In some example embodiments, a positive value for the local Moran's I statistic Iᵢ may indicate that there is a spatial cluster of similar values whereas a negative value for the local Moran's I statistic Iᵢ may indicate that there is a spatial cluster of dissimilar values. Accordingly, the spatial analysis engine 156 may determine a first local Moran's I statistic for a first region of the biological sample in the image 125 based on a first count of mitotic figures present in the first region and a weighted sum of mitotic figures present in each of a plurality of other regions. The weighted sum of mitotic figures present each of the plurality of other regions may include, for example, a second count of mitotic figures present in a second region where the second count is associated with a first weight if the second region is adjacent to the first region and a second weight if the second region is not adjacent to the first region. In the context of local Moran's I statistic, the first region and the second region may be considered adjacent if the second region is within a threshold distance of the first region. Alternatively, the first region and the second region may be considered adjacent if a first border of the first region overlaps at least a portion of a second border of the second region. In some cases, the spatial analysis engine 156 may determine, based at least on the first local Moran's I statistic of the first region and a second local Moran's I statistic for a second region adjacent to the first region, that the first region and the second region exhibit a high-high spatial association, a low-low spatial association, a high-low spatial association, or a low-high spatial association.

In some example embodiments, a local Geary's C statistic is another example of the mitotic metric quantifying the spatial distribution of mitotic figures in the image 125 of the biological sample. In some cases, the local Geary's C statistic may quantify a local spatial autocorrelation of the mitotic figures present different regions in the biological sample depicted in the image 125. For example, in some cases, the spatial analysis engine 156 may determine a Geary's C statistic of the mitotic figures in the biological sample by applying Equation (5) below.

$$C = \frac{n - 1}{2 {Σ}_{i}^{n} {Σ}_{j}^{n} {w}_{i j}} \frac{{Σ}_{i}^{n} {Σ}_{j}^{n} {{w}_{i j} ( {z}_{i} - {z}_{j} )}^{2}}{{Σ}_{i}^{n} {( {z}_{i} - \overline{z} )}^{2}} \qquad ( 5 )$$

wherein zᵢ denotes the prevalence of mitotic figures at the areal unit i, z̅ denotes an average of the prevalence z of mitotic figures across the areal units, and wᵢⱼ denotes the binary having a first value (e.g., 1) if two areal units are neighbors and a second value (e.g., 0) if two areal units are not neighbors.

The value of a local Geary's C statistic may be further determined by applying Equation (6) below.

$$L {C}_{i} = {\sum }_{j} {{w}_{i j} ( {z}_{i} - {z}_{j} )}^{2}$$

wherein zᵢ denotes the prevalence of mitotic figures at the areal unit i and wᵢⱼ denotes the binary having a first value (e.g., 1) if two areal units are neighbors and a second value (e.g., 0) if two areal units are not neighbors.

In some cases, the spatial analysis engine 156 may determine, for each region of a plurality of regions in the biological sample depicted in the image 125, a corresponding local Geary's C statistic. For example, the spatial analysis engine 156 may determine a first local Geary's C statistic of a first region corresponding to a weighted sum of differences in a first count of mitotic figures present in the first region and a count of mitotic figures present in each the other regions. The aforementioned weighted sum may include, for example, a difference between the first count of mitotic figures present in the first region and a second count of mitotic figures present in a second region. In some cases, the difference may be associated with a first weight if the second region is adjacent to the first region and a second weight if the second region is not adjacent to the first region. Moreover, in some cases, the spatial analysis engine 156 may determine, based at least on the first local Geary's C statistic of the first region and a second local Geary's C statistic for a second region adjacent to the first region, that the first region and the second region exhibits a high-high spatial association or a low-low spatial association.

Table 1 below depicts a comparison of Spearman correlations for a conventional mitotic metric such as average mitotic score (or mitotic density) and some examples of the mitotic metrics described herein. As shown in Table 1, when the analyzed region includes all tissue (e.g., tumor and non-tumor tissue), the absolute value of Spearman correlation with tumor grade improved significantly from 0.466 for whole slide average mitotic score (mitotic density) to 0.537 when the mitotic metric of average nearest neighbor distance is used. The absolute value of Spearman correlation is further improved to 0.597 when the mitotic metric of average neighbor count within a radius is used. Meanwhile, when the analyzed region includes those regions having a greater than 50% probability of being a tumor region (e.g., tumor region >0.5, the absolute value of Spearman correlation with tumor grade improved from 0.582 for whole slide average mitotic score (mitotic density) to 0.603 when the mitotic metric of average nearest neighbor distance is used and to 0.597 when the mitotic metric of average neighbor count within a radius is used.

TABLE 1

| | | average nearest | average | optimal |
|---|---|---|---|---|
| analyzed | average | mitotic neighbor | neighbor | radius for |
| region: | mitotic score | distance | count | neighbor count |
| All tissue: | 0.4659991084 | −0.5374747838 | 0.5967765362 | 200 |
| Tumor region > | 0.5819922208 | −0.6026497605 | 0.593549429 | 200 |
| 0.5: | | | | |

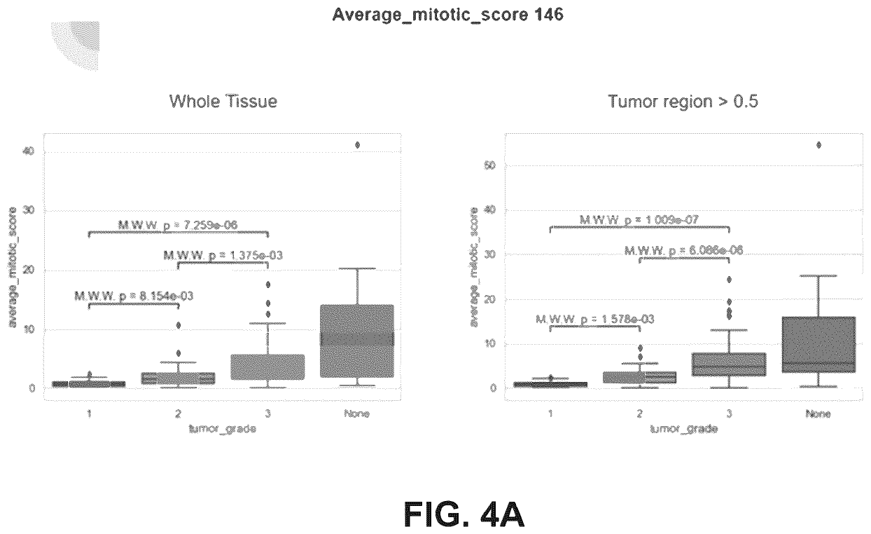

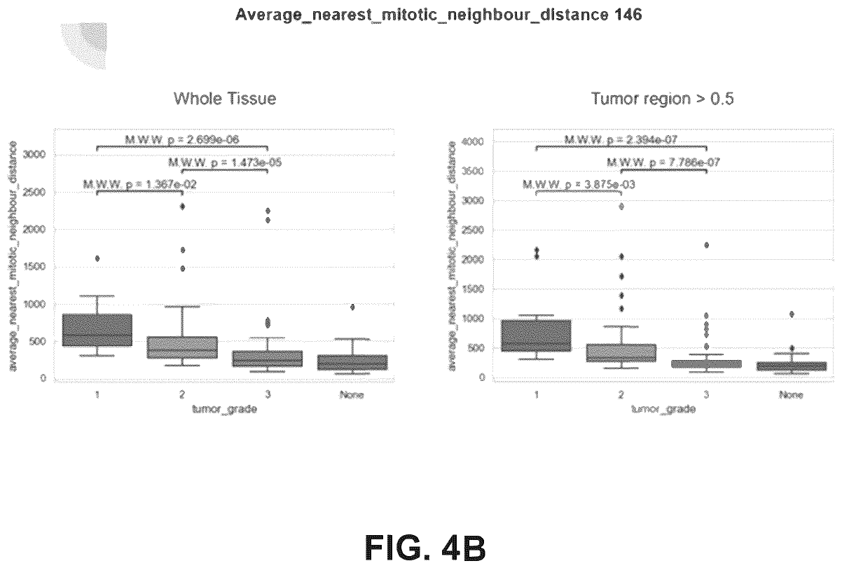

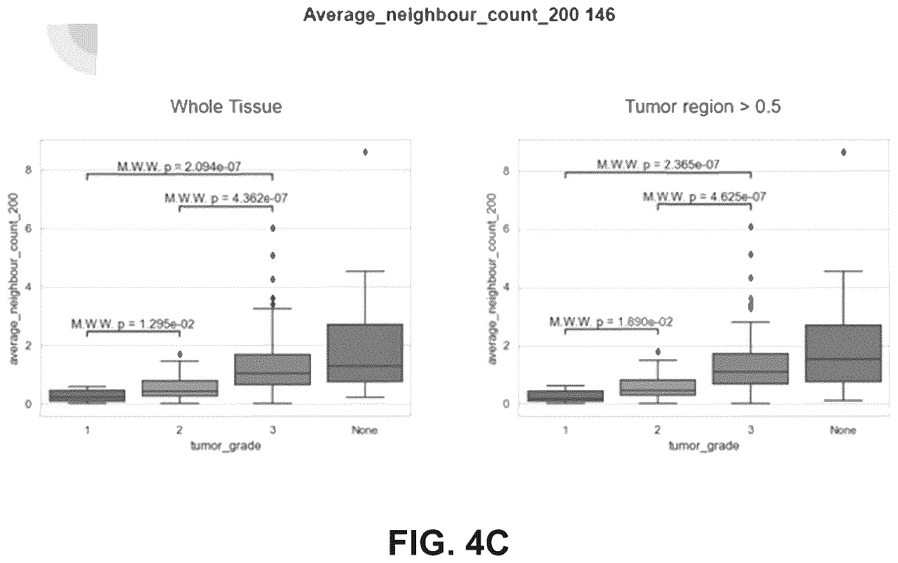

Table 2 below depicts a comparison of p-values, which indicate the probability that a hypothesis is not statistically significant, for a conventional mitotic metric such as average mitotic score (or mitotic density) and some examples of the mitotic metrics described herein. As shown in Table 2, the mitotic metrics average nearest neighbor distance and average neighbor count within a radius exhibits significantly better (e.g., lower) p-values than the conventional mitotic metric of average mitotic score (or mitotic density). In this context, the hypothesis associated with the p-value may be that a certain mitotic metric has significantly different distribution for a pair of tumor grades. FIGS. 4A-C depict boxplots depicting the distributions associated with the conventional mitotic metric of average mitotic score (or mitotic density) and the mitotic metrics average nearest neighbor distance and average neighbor count within a radius.

TABLE 2

| tumor | | | average nearest | average | optimal |
|---|---|---|---|---|---|
| grades | | average | mitotic neighbor | neighbor | radius for |
| compared | analyzed region | mitotic score | distance | count | neighbor count |
| 1 vs 2 | All Tissue | 8.154e−03 | 1.367e−02 | 9.566e−04 | 350 |
| | Tumor region > 0.5 | 1.578e−03 | 3.875e−03 | 2.479e−03 | 350 |
| 2 vs 3 | All Tissue | 1.375e−03 | 1.473e−05 | 4.362e−07 | 200 |
| | Tumor region > 0.5 | 6.086e−06 | 7.786e−07 | 3.904e−07 | 250 |
| 1 vs 3 | All Tissue | 7.259e−06 | 2.699e−06 | 2.094e−07 | 200 |
| | Tumor region > 0.5 | 1.009e−07 | 2.394e−07 | 2.365e−07 | 200 |

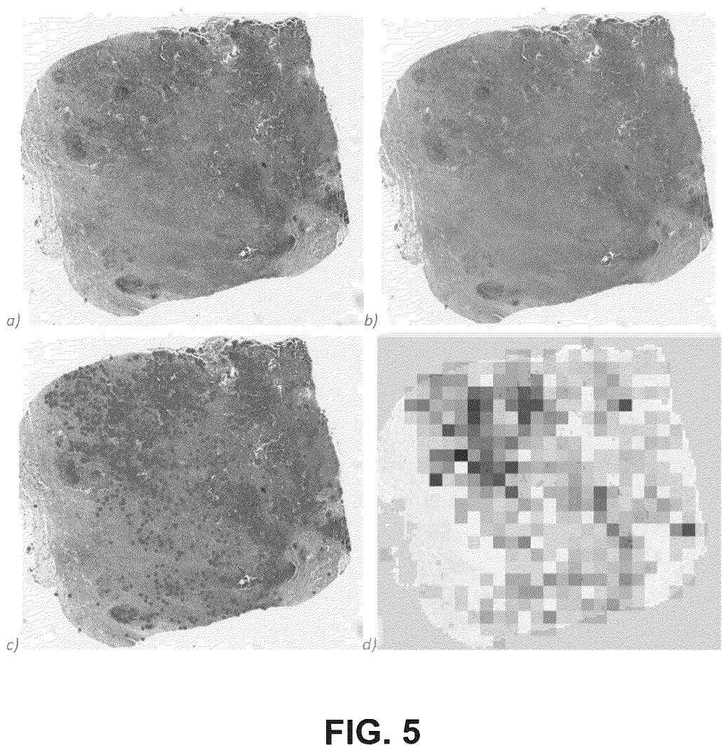

In some example embodiments, the digital pathology platform 110, for example, the spatial analysis engine 156, may generate one or more visualizations of the mitotic figures present in the image 125. In some cases, the spatial analysis engine 156 may generate the one or more visualizations for display as a part of a user interface 135 at the client device 130. To further illustrate, FIG. 5(a) depicts an example of the image 125 of the biological sample while FIG. 5(b) depicts a result of the segmentation performed, for example, by the segmentation engine 152 where one or more regions of the image 125 are identified for exclusion from subsequent identification of mitotic figures. For example, in some cases, the identification of mitotic figures may be limited to the first region of the image 125 corresponding to the tumor tissue. In some cases, the identification of mitotic figures may be further limited to one or more regions of the image 125 where the level of tumor activity satisfy one or more thresholds. The result of mitotic figure localization, which is shown in FIG. 5(c), may therefore exclude the second region of the image 125 corresponding to the non-tumor tissue, the third region of the image 125 exhibiting a below-threshold tumor activity, and/or the fourth region of the image 125 corresponding to the background of the image 125. FIG. 5(d) depicts an example of a heatmap having different visual indicators corresponding to the different levels of mitotic activity present in various regions of the biological sample. In some cases, the level of mitotic activity in a region of the biological sample may be determined by the quantity of mitotic figures identified in the region.

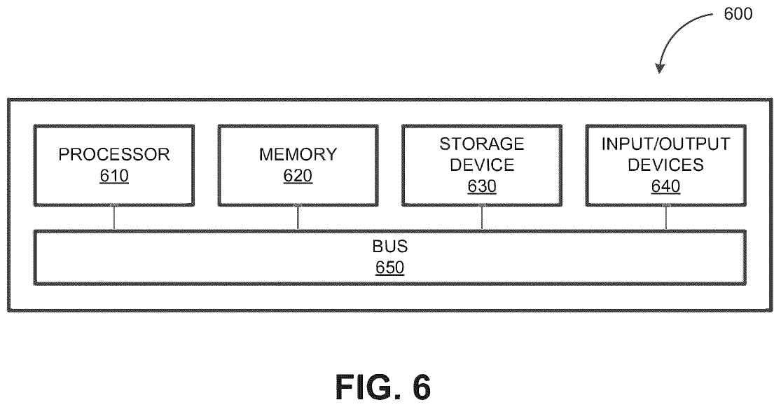

FIG. 6 depicts a block diagram illustrating an example of computing system 600, in accordance with some example embodiments. Referring to FIGS. 1-6, the computing system 600 may be used to implement the digital pathology platform 110, the imaging system 120, the client device 130, and/or any components therein.

As shown in FIG. 6, the computing system 600 can include a processor 610, a memory 620, a storage device 630, and input/output devices 640. The processor 610, the memory 620, the storage device 630, and the input/output devices 640 can be interconnected via a system bus 650. The processor 610 is capable of processing instructions for execution within the computing system 600. Such executed instructions can implement one or more components of, for example, the digital pathology platform 110, the client device 130, and/or the like. In some example embodiments, the processor 610 can be a single-threaded processor. Alternately, the processor 610 can be a multi-threaded processor. The processor 610 is capable of processing instructions stored in the memory 620 and/or on the storage device 630 to display graphical information for a user interface provided via the input/output device 640.

The memory 620 is a computer readable medium such as volatile or non-volatile that stores information within the computing system 600. The memory 620 can store data structures representing configuration object databases, for example. The storage device 630 is capable of providing persistent storage for the computing system 600. The storage device 630 can be a floppy disk device, a hard disk device, an optical disk device, a tape device, or other suitable persistent storage means. The input/output device 640 provides input/output operations for the computing system 600. In some example embodiments, the input/output device 640 includes a keyboard and/or pointing device. In various implementations, the input/output device 640 includes a display unit for displaying graphical user interfaces.

According to some example embodiments, the input/output device 640 can provide input/output operations for a network device. For example, the input/output device 640 can include Ethernet ports or other networking ports to communicate with one or more wired and/or wireless networks (e.g., a local area network (LAN), a wide area network (WAN), the Internet).

In some example embodiments, the computing system 600 can be used to execute various interactive computer software applications that can be used for organization, analysis and/or storage of data in various formats. Alternatively, the computing system 600 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 640. The user interface can be generated and presented to a user by the computing system 600 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

### EMBODIMENTS

Among the provided embodiments are:
1. A computer-implemented method, comprising:
   identifying, within an image of a biological sample, a plurality of mitotic figures associated with a tumor tissue present in the biological sample, each mitotic figure of the plurality of mitotic figures corresponding to a tumor cell that is undergoing mitosis;
   determining, based at least on the plurality of mitotic figures in the biological sample, a mitotic metric quantifying a spatial distribution of the plurality of mitotic figures within the biological sample; and
   determining, based at least on the mitotic metric, a tumor grade for the tumor tissue present in the biological sample.
2. The method of Embodiment 1, wherein the mitotic metric comprises an average nearest neighbor distance.
3. The method of Embodiment 2, further comprising:
   determining a distance between each pair of mitotic figures included in the plurality of mitotic figures;
   identifying, based at least on the distance between each pair of mitotic figures included in the plurality of mitotic figures, a shortest distance between each mitotic figure of the plurality of mitotic figures and another mitotic figure in the plurality of mitotic figures; and
   determining, based at least on the shortest distance between each mitotic figure of the plurality of mitotic figures and the another mitotic figure in the plurality of mitotic figures, the average nearest neighbor distance.
4. The method of Embodiment 1, wherein the mitotic metric comprises an average neighbor count within a radius.
5. The method of Embodiment 4, further comprising:
   determining a distance between each pair of mitotic figures included in the plurality of mitotic figures; and
   determining, based at least on the distance between each pair of mitotic figures included in the plurality of mitotic figures, a count of one or more other mitotic figures that are within the radius of each mitotic figure in the plurality of mitotic figures.
6. The method of Embodiment 1, wherein the mitotic metric comprises a Clark-Evans (CE) index corresponding to a ratio between an average nearest neighbor distance and an expected nearest neighbor distance for the biological sample.
7. The method of Embodiment 6, further comprising:
   determining, for each mitotic figure of the plurality of mitotic figures, a distance to another mitotic figure of the plurality of mitotic figures that is a nearest neighbor;
   determining, for the plurality of mitotic figures, the average nearest neighbor distance for the biological sample; and
   determining, based at least on a count of the plurality of mitotic figures and a size of the tumor in the biological sample, the expected average neighbor distance for the biological sample.
8. The method of Embodiment 6, further comprising:
   determining, based at least on the Clark-Evans (CE) index being less than a threshold value, that the plurality of mitotic figures in the biological sample exhibits an aggregated spatial distribution;
   determining, based at least on the Clark-Evans (CE) index being equal to the threshold value, that the plurality of mitotic figures in the biological sample exhibits a random spatial distribution; and
   determining, based at least on the Clark-Evans (CE) index being greater than the threshold value, that the plurality of mitotic figures in the biological sample exhibits an even spatial distribution.
9. The method of Embodiment 6, wherein the size of the tumor corresponds to a two-dimensional area of the tumor or a three-dimensional volume of the tumor.
10. The method of Embodiment 1, wherein the mitotic metric comprises a measure of local spatial autocorrelation.
11. The method of Embodiment 1, wherein the mitotic metric comprises a local Moran's I statistic for each region of a plurality of regions in the image of the biological sample.
12. The method of Embodiment 11, wherein a first local Moran's I statistic for a first region of the plurality of regions is determined based on a first count of mitotic figures present in the first region and a weighted sum of mitotic figures present in each of a plurality of other regions.
13. The method of Embodiment 12, wherein the weighted sum of mitotic figures present each of the plurality of other regions includes a second count of mitotic figures present in a second region, wherein the second count is associated with a first weight based on the second region being adjacent to the first region, and wherein the second count is associated with a second weight based on the second region not being adjacent to the first region.
14. The method of Embodiment 13, further comprising:
   determining, based at least on the first local Moran's I statistic of the first region and a second local Moran's I statistic for a second region adjacent to the first region, that the first region and the second region exhibits a high-high spatial association, a low-low spatial association, a high-low spatial association, or a low-high spatial association.
15. The method of Embodiment 1, wherein the mitotic metric comprises a local Geary's C statistic for each region of a plurality of regions in the image of the biological sample.
16. The method of Embodiment 15, wherein a first local Geary's C statistic of a first region of the plurality of regions corresponds to a weighted sum of differences in a first count of mitotic figures present in the first region and a count of mitotic figures present in each of a plurality of other regions.
17. The method of Embodiment 16, wherein the weighted sum includes a difference between the first count of mitotic figures present in the first region and a second count of mitotic figures present in a second region of the plurality of regions, wherein the difference is associated with a first weight based on the second region being adjacent to the first region, and wherein the different is associated with a second weight based on the second region not being adjacent to the first region.
18. The method of Embodiment 16, further comprising:
   determining, based at least on the first local Geary's C statistic of the first region and a second local Geary's C statistic for a second region adjacent to the first region, that the first region and the second region exhibits a high-high spatial association or a low-low spatial association.
19. The method of Embodiment 1, wherein the mitotic metric comprises an average mitotic density corresponding to a ratio between a count of the plurality of mitotic figures and an area of the tumor tissue.
20. The method of Embodiment 1, wherein the grade of the tumor tissue is one of well differentiated, moderately differentiated, poorly differentiated, or undifferentiated.
21. The method of Embodiment 1, further comprising:
   determining, based at least on the tumor grade, a survival prognosis for the patient associated with the biological sample.
22. The method of Embodiment 1, further comprising:
   segmenting the image of the biological sample into a first region corresponding to the tumor tissue and a second region corresponding to a non-tumor tissue; and
   excluding, from the plurality of mitotic figures, one or more mitotic figures identified within the second region of the image.
23. The method of Embodiment 22, wherein the non-tumor tissue includes a fat tissue and/or a normal tissue.
24. The method of Embodiment 1, further comprising:
   identifying, within the image of the biological sample, one or more background portions of the image; and
   omitting the one or more background portions of the image during the identifying of the plurality of mitotic figures.
25. The method of Embodiment 1, further comprising:
   determining, for each region of a plurality of regions of the tumor tissue, an intensity metric corresponding to an activity of the tumor within the region; and
   excluding, from the plurality of mitotic figures, one or more mitotic figures identified within a region whose intensity metric fails to satisfy one or more thresholds.
26. The method of Embodiment 1, further comprising:
   partitioning the image of the biological sample into a plurality of regions; and
   generating a visual representation in which each region of the plurality of regions is displayed using a color and/or a color intensity corresponding to a count of mitotic figures present in the region.
27. The method of Embodiment 1, wherein the tumor grade is further determined based on a another mitotic metric corresponding a count of mitotic figures identified in one or more fields-of-view of the image of the biological sample.
28. The method of Embodiment 27, wherein the one or more fields of view are associated with a magnification level satisfying one or more thresholds.
29. A system, comprising:
   at least one data processor; and
   at least one memory storing instructions, which when executed by the at least one data processor, result in operations comprising the method of any of Embodiments 1 to 28.
30. A non-transitory computer readable medium storing instructions, which when executed by at least one data processor, result in operations comprising the method of any of Embodiments 1 to 28.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A computer-implemented method, comprising:
identifying, within an image of a biological sample, a plurality of mitotic figures associated with a tumor tissue present in the biological sample, each mitotic figure of the plurality of mitotic figures corresponding to a tumor cell that is undergoing mitosis;
determining, based at least on the plurality of mitotic figures in the biological sample, a mitotic metric quantifying a spatial distribution of the plurality of mitotic figures within the biological sample; and
determining, based at least on the mitotic metric, a tumor grade for the tumor tissue present in the biological sample.

2. The method of claim 1, wherein the mitotic metric comprises an average nearest neighbor distance, the method further comprising:
determining a distance between each pair of mitotic figures included in the plurality of mitotic figures;
identifying, based at least on the distance between each pair of mitotic figures included in the plurality of mitotic figures, a shortest distance between each mitotic figure of the plurality of mitotic figures and another mitotic figure in the plurality of mitotic figures; and
determining, based at least on the shortest distance between each mitotic figure of the plurality of mitotic figures and the another mitotic figure in the plurality of mitotic figures, the average nearest neighbor distance.

3. The method of claim 1, wherein the mitotic metric comprises an average neighbor count within a radius, the method further comprising:
determining a distance between each pair of mitotic figures included in the plurality of mitotic figures; and
determining, based at least on the distance between each pair of mitotic figures included in the plurality of mitotic figures, a count of one or more other mitotic figures that are within the radius of each mitotic figure in the plurality of mitotic figures.

4. The method of claim 1, wherein the mitotic metric comprises a Clark-Evans (CE) index corresponding to a ratio between an average nearest neighbor distance and an expected nearest neighbor distance for the biological sample.

5. The method of claim 4, further comprising:
determining, for each mitotic figure of the plurality of mitotic figures, a distance to another mitotic figure of the plurality of mitotic figures that is a nearest neighbor;
determining, for the plurality of mitotic figures, the average nearest neighbor distance for the biological sample; and
determining, based at least on a count of the plurality of mitotic figures and a size of the tumor in the biological sample, the expected average neighbor distance for the biological sample.

6. The method of claim 4, further comprising:
determining, based at least on the Clark-Evans (CE) index being less than a threshold value, that the plurality of mitotic figures in the biological sample exhibits an aggregated spatial distribution;
determining, based at least on the Clark-Evans (CE) index being equal to the threshold value, that the plurality of mitotic figures in the biological sample exhibits a random spatial distribution; and
determining, based at least on the Clark-Evans (CE) index being greater than the threshold value, that the plurality of mitotic figures in the biological sample exhibits an even spatial distribution.

7. The method of claim 1, wherein the mitotic metric comprises a measure of local spatial autocorrelation.

8. The method of claim 1, wherein the mitotic metric comprises a local Moran's I statistic for each region of a plurality of regions in the image of the biological sample, and wherein a first local Moran's I statistic for a first region of the plurality of regions is determined based on a first count of mitotic figures present in the first region and a weighted sum of mitotic figures present in each of a plurality of other regions.

9. The method of claim 8, wherein the weighted sum of mitotic figures present each of the plurality of other regions includes a second count of mitotic figures present in a second region, wherein the second count is associated with a first weight based on the second region being adjacent to the first region, and wherein the second count is associated with a second weight based on the second region not being adjacent to the first region, the method further comprising: determining, based at least on the first local Moran's I statistic of the first region and a second local Moran's I statistic for a second region adjacent to the first region, that the first region and the second region exhibits a high-high spatial association, a low-low spatial association, a high-low spatial association, or a low-high spatial association.

10. The method of claim 1, wherein the mitotic metric comprises a local Geary's C statistic for each region of a plurality of regions in the image of the biological sample, wherein a first local Geary's C statistic of a first region of the plurality of regions corresponds to a weighted sum of differences in a first count of mitotic figures present in the first region and a count of mitotic figures present in each of a plurality of other regions.

11. The method of claim 10, wherein the weighted sum includes a difference between the first count of mitotic figures present in the first region and a second count of mitotic figures present in a second region of the plurality of regions, wherein the difference is associated with a first weight based on the second region being adjacent to the first region, and wherein the different is associated with a second weight based on the second region not being adjacent to the first region.

12. The method of claim 10, further comprising:
determining, based at least on the first local Geary's C statistic of the first region and a second local Geary's C statistic for a second region adjacent to the first region, that the first region and the second region exhibits a high-high spatial association or a low-low spatial association.

13. The method of claim 1, wherein the mitotic metric comprises an average mitotic density corresponding to a ratio between a count of the plurality of mitotic figures and an area of the tumor tissue.

14. The method of claim 1, further comprising:
determining, based at least on the tumor grade, a survival prognosis for the patient associated with the biological sample.

15. The method of claim 1, further comprising:
segmenting the image of the biological sample into a first region corresponding to the tumor tissue and a second region corresponding to a non-tumor tissue, wherein the non-tumor tissue includes a fat tissue and/or a normal tissue; and
excluding, from the plurality of mitotic figures, one or more mitotic figures identified within the second region of the image.

16. The method of claim 1, further comprising:
identifying, within the image of the biological sample, one or more background portions of the image; and
omitting the one or more background portions of the image during the identifying of the plurality of mitotic figures.

17. The method of claim 1, further comprising:
determining, for each region of a plurality of regions of the tumor tissue, an intensity metric corresponding to an activity of the tumor within the region; and
excluding, from the plurality of mitotic figures, one or more mitotic figures identified within a region whose intensity metric fails to satisfy one or more thresholds.

18. The method of claim 1, wherein the tumor grade is further determined based on an another mitotic metric corresponding a count of mitotic figures identified in one or more fields-of-view of the image of the biological sample, and wherein the one or more fields of view are associated with a magnification level satisfying one or more thresholds.

19. A system, comprising:
at least one data processor; and
at least one memory storing instructions, which when executed by the at least one data processor, result in operations comprising:
identifying, within an image of a biological sample, a plurality of mitotic figures associated with a tumor tissue present in the biological sample, each mitotic figure of the plurality of mitotic figures corresponding to a tumor cell that is undergoing mitosis;
determining, based at least on the plurality of mitotic figures in the biological sample, a mitotic metric quantifying a spatial distribution of the plurality of mitotic figures within the biological sample; and
determining, based at least on the mitotic metric, a tumor grade for the tumor tissue present in the biological sample.

20. A non-transitory computer readable medium storing instructions, which when executed by at least one data processor, result in operations comprising:
identifying, within an image of a biological sample, a plurality of mitotic figures associated with a tumor tissue present in the biological sample, each mitotic figure of the plurality of mitotic figures corresponding to a tumor cell that is undergoing mitosis;
determining, based at least on the plurality of mitotic figures in the biological sample, a mitotic metric quantifying a spatial distribution of the plurality of mitotic figures within the biological sample; and
determining, based at least on the mitotic metric, a tumor grade for the tumor tissue present in the biological sample.
